(19) United States
(12) Patent Application Publication
(10) Pub. No.: US 2026/0330112 A1
(43) Pub. Date: Oct. 22, 2026

(54) NETWORK DESIGN SYSTEM AND NETWORK DESIGN METHOD

(71) Applicant: MEDIATEK INC., Hsinchu City (TW)

(72) Inventors: Han-Cheng YAO, Hsinchu City (TW); Chao-Hsuan HSU, Hsinchu City (TW); Bao-Hong LAI, Hsinchu City (TW); Kuan-Lin WU, Hsinchu City (TW); Tung-Yu LEE, Hsinchu City (TW); Shao-Wen CHENG, Hsinchu City (TW); Chung-An WANG, Hsinchu City (TW); Yang-Sheng CHAO, Hsinchu City (TW)

(21) Appl. No.: 19/642,878

(22) Filed: Apr. 9, 2026

Related U.S. Application Data
(60) Provisional application No. 63/790,807, filed on Apr. 18, 2025.

(51) Int. Cl. G06F 30/327; G06F 115/02; G06N 3/042; G06N 3/092

(52) U.S. Cl. CPC G06F 30/327; G06N 3/042; G06N 3/092; G06F 2115/02

(57) ABSTRACT

A network design system includes a memory and a processor. The memory is configured to store a plurality of commands and a deep reinforcement learning (DRL) engine. The processor is configured to execute following steps according to the plurality of commands of the memory: obtaining a plurality of topology synthesis data by the deep reinforcement learning (DRL) engine according to input specification data and cost function data; and outputting optimized topology data through the deep reinforcement learning (DRL) engine by comparing the plurality of topology synthesis data. The optimized topology data is related to a maximum value of reward data. The reward data is related to the cost function data.

### CROSS REFERENCE TO RELATED APPLICATIONS

This application claims priority of U.S. Provisional Application No. 63/790,807, filed on Apr. 18, 2025, the entirety of which is incorporated by reference herein.

### BACKGROUND OF THE INVENTION

### Field of the Invention

The present invention relates to a design system and design method, and, in particular, it is related to a network design system and network design method.

### Description of the Related Art

At present, in network-on-chip (NoC) synthesis technologies, the design flow typically adopts a segmented optimization approach, in which the overall synthesis task is decomposed into multiple independent subproblems that are addressed separately rather than being optimized simultaneously.

Under such a technical approach, the construction of the topology, the configuration of clock parameters and data width, and the planning of routing paths are generally treated as mutually independent stages.

In addition, many existing technologies employ non-end-to-end design methodologies, which leads to noticeable discontinuities in the design flow.

As a result, multiple intermediate steps or switching between different toolchains are often required in order to transform an initial system-on-chip (SoC) specification into a final implementation.

Furthermore, such approaches often rely heavily on substantial manual intervention based on engineering experience, or require the use of specific heuristic rules to guide adjustment and design, thereby lacking the capability for automated transformation and self-learning.

Accordingly, a network design system or device capable of performing automated transformation and self-learning is highly desirable and warrants further research and development.

### BRIEF SUMMARY OF THE INVENTION

An embodiment of the present invention provides a network design system. The network design system includes a memory and a processor. The memory is configured to store a plurality of commands and a deep reinforcement learning (DRL) engine. The processor is configured to execute following steps according to the plurality of commands of the memory: obtaining a plurality of topology synthesis data by the deep reinforcement learning (DRL) engine according to input specification data and cost function data; and outputting optimized topology data through the deep reinforcement learning (DRL) engine by comparing the plurality of topology synthesis data. The optimized topology data is related to a maximum value of reward data. The reward data is related to the cost function data.

In one embodiment, the processor executes the following steps according to the plurality of commands of the memory: formulating one of the plurality of topology synthesis data as a reinforcement learning (RL) task data by the deep reinforcement learning (DRL) engine; and jointly optimizing the topology synthesis data, clock config data, data-width config data, and routing path data according to the reinforcement learning (RL) task data; wherein the reinforcement learning (RL) task data is related to a topology transformation data.

In one embodiment, the processor executes the following steps according to the plurality of commands of the memory: encoding dynamic topology state data as graph data by reinforcement learning agent with graph neural network data according to the reinforcement learning (RL) task data; and obtaining a value of the cost function data by the deep reinforcement learning (DRL) engine according to the graph data; wherein the reinforcement learning agent is related to the deep reinforcement learning (DRL) engine; wherein the graph neural network data is related to the deep reinforcement learning (DRL) engine; wherein the graph data is related to one of the plurality of topology synthesis data; wherein one of the plurality of topology synthesis data corresponds to end-to-end topology data.

In one embodiment, the processor executes the following steps according to the plurality of commands of the memory: obtaining first topology state data by the reinforcement learning agent; observing first current topology data of the first topology state data by the reinforcement learning agent; transforming first topology structure data of the plurality of topology synthesis data by the reinforcement learning agent; obtaining a first difference value of the cost function data as the reward data; obtaining second topology state data by the reinforcement learning agent; observing second current topology data of the second topology state data by the reinforcement learning agent; transforming second topology structure data of the plurality of topology synthesis data by the reinforcement learning agent; obtaining a second difference value of the cost function data as the reward data; and outputting the optimized topology data through the deep reinforcement learning (DRL) engine according to the reward data; wherein the first topology state data and the second topology state data are related to the plurality of topology synthesis data; wherein the first current topology data and the second current topology data are related to the plurality of topology synthesis data.

In one embodiment, the topology synthesis data is related to a Markov decision process (MDP); wherein the deep reinforcement learning (DRL) engine includes graph neural network data and deep q-network data; wherein the plurality of topology synthesis data are related to joint topology construction data, topology attribute data, and routing path data.

In one embodiment, the topology synthesis data is related to a network-on-chip (NoC) data; wherein the processor executes the following steps according to the plurality of commands of the memory: modifying communication path data to minimize power data and area data by reinforcement learning agent while meeting performance constraint data; wherein the cost function data includes the power data and the area data; wherein the communication path data is related to the routing path data; wherein the deep reinforcement learning (DRL) engine includes the reinforcement learning agent.

In one embodiment, the processor executes the following steps according to the plurality of commands of the memory: optimizing topology data through the reinforcement learning agent by merging or decoding the communication path data; wherein the topology data is related to the optimized topology data.

In one embodiment, the processor executes the following steps according to the plurality of commands of the memory: optimizing the topology data through the reinforcement learning agent by assigning a plurality of attribute data to the topology data; wherein the plurality of attribute data includes clock config data and data-width config data.

In one embodiment, the processor executes the following steps according to the plurality of commands of the memory: encoding topology state data by the graph neural network data while optimizing the topology data; wherein the topology state data is related to the topology data; wherein the topology state data includes current topology data, the plurality of attribute data, routing path status data; wherein the routing path status data is related to the routing path data; wherein the topology state data correspond to state feature data and graph data.

In one embodiment, the processor executes the following steps according to the plurality of commands of the memory: obtaining the input specification data by an input interface; verifying and outputting the optimized topology data by an output module; jointly optimizing at least one of protocol data, link type data, voltage data, and custom attribute data according to the reinforcement learning (RL) task data; and jointly optimizing Network-on-Chip (NoC) topology design dimension data according to the reinforcement learning (RL) task data; wherein the network design system further includes the input interface and the output module; wherein the plurality of topology synthesis data comprise at least one of the protocol data, the link type data, the voltage data, and the custom attribute data; wherein the protocol data, the link type data, the voltage data, and the custom attribute data are related to the cost function data; wherein the Network-on-Chip (NoC) topology design dimension data is related to one of the plurality of topology synthesis data.

Other embodiment of the present invention provides a network design method. The network design method includes the following steps: obtaining a plurality of topology synthesis data by a deep reinforcement learning (DRL) engine according to input specification data and cost function data; and outputting optimized topology data through the deep reinforcement learning (DRL) engine by comparing the plurality of topology synthesis data. The optimized topology data is related to a maximum value of reward data. The reward data is related to the cost function data.

In one embodiment, the network design method further includes the following steps: formulating one of the plurality of topology synthesis data as a reinforcement learning (RL) task data by the deep reinforcement learning (DRL) engine; and jointly optimizing the topology synthesis data, clock config data, data-width config data, and routing path data according to the reinforcement learning (RL) task data; wherein the reinforcement learning (RL) task data is related to a topology transformation data.

In one embodiment, the network design method further includes the following steps: encoding dynamic topology state data as graph data by reinforcement learning agent with graph neural network data according to the reinforcement learning (RL) task data; and obtaining a value of the cost function data by the deep reinforcement learning (DRL) engine according to the graph data; wherein the reinforcement learning agent is related to the deep reinforcement learning (DRL) engine; wherein the graph neural network data is related to the deep reinforcement learning (DRL) engine; wherein the graph data is related to one of the plurality of topology synthesis data; wherein one of the plurality of topology synthesis data corresponds to end-to-end topology data.

In one embodiment, the network design method further includes the following steps: obtaining first topology state data by the reinforcement learning agent; observing first current topology data of the first topology state data by the reinforcement learning agent; transforming first topology structure data of the plurality of topology synthesis data by the reinforcement learning agent; obtaining a first difference value of the cost function data as the reward data; obtaining second topology state data by the reinforcement learning agent; observing second current topology data of the second topology state data by the reinforcement learning agent; transforming second topology structure data of the plurality of topology synthesis data by the reinforcement learning agent; obtaining a second difference value of the cost function data as the reward data; and outputting the optimized topology data through the deep reinforcement learning (DRL) engine according to the reward data; wherein the first topology state data and the second topology state data are related to the plurality of topology synthesis data; wherein the first current topology data and the second current topology data are related to the plurality of topology synthesis data.

In one embodiment, the topology synthesis data is related to a Markov decision process (MDP); wherein the deep reinforcement learning (DRL) engine includes graph neural network data and deep q-network data; wherein the plurality of topology synthesis data are related to joint topology construction data, topology attribute data, and routing path data.

In one embodiment, the network design method further includes the following steps: modifying communication path data to minimize power data and area data by reinforcement learning agent while meeting performance constraint data; wherein the cost function data includes the power data and the area data; wherein the communication path data is related to the routing path data; the deep reinforcement learning (DRL) engine includes the reinforcement learning agent; wherein the topology synthesis data is related to a network-on-chip (NoC) data.

In one embodiment, the network design method further includes the following steps: optimizing topology data through the reinforcement learning agent by merging or decoding the communication path data; wherein the topology data is related to the optimized topology data.

In one embodiment, the network design method further includes the following steps: optimizing the topology data through the reinforcement learning agent by assigning a plurality of attribute data to the topology data; wherein the plurality of attribute data includes clock config data and data-width config data.

In one embodiment, the network design method further includes the following steps: encoding topology state data by the graph neural network data while optimizing the topology data; wherein the topology state data is related to the topology data; wherein the topology state data includes current topology data, the plurality of attribute data, routing path status data; wherein the routing path status data is related to the routing path data; wherein the topology state data correspond to state feature data and graph data.

In one embodiment, the network design method further includes the following steps: obtaining the input specification data by an input interface; verifying and outputting the optimized topology data by an output module; wherein the network design system further includes the input interface and the output module; jointly optimizing at least one of protocol data, link type data, voltage data, and custom attribute data according to the reinforcement learning (RL) task data; and jointly optimizing Network-on-Chip (NoC) topology design dimension data according to the reinforcement learning (RL) task data; wherein the network design system comprises the network design method; wherein the plurality of topology synthesis data comprise at least one of the protocol data, the link type data, the voltage data, and the custom attribute data; wherein the protocol data, the link type data, the voltage data, and the custom attribute data are related to the cost function data; wherein the Network-on-Chip (NoC) topology design dimension data is related to one of the plurality of topology synthesis data.

Therefore, according to the technical content of the present disclosure, the network design system and network design method shown in the embodiment of the present disclosure can achieve the effect of performing automated transformation and self-learning.

Other features and aspects of the present disclosure will become apparent from the following detailed description of exemplary embodiments with reference to the accompanying drawings.

After reviewing the embodiments described below, those having ordinary skill in the art will readily understand the basic spirit and other objectives of the present invention, as well as the technical means and implementation modes adopted by the present invention.

### BRIEF DESCRIPTION OF THE DRAWINGS

The views of the embodiments of the present disclosure can be better understood through the following detailed description combined with the accompanying drawings. It is worth noting that, according to standard industrial practice, some features may not be drawn to scale. In fact, to facilitate clear description, the dimensions of different features may be increased or decreased, wherein:

FIG. 1 is a block diagram of a network design system according to one embodiment of the present disclosure.

FIG. 2 is a flowchart diagram of a network design system according to one embodiment of the present disclosure.

FIG. 3 is a flowchart diagram of a network design system according to one embodiment of the present disclosure.

FIG. 4 is a flowchart diagram of a network design system according to one embodiment of the present disclosure.

FIG. 5 is a flowchart diagram of a network design system according to one embodiment of the present disclosure.

FIG. 6 is a schematic flowchart of a network design method according to one embodiment of the present disclosure.

According to conventional practice, the various features and components illustrated in the drawings are depicted in a manner that best represents the specific features and components relevant to the present invention. In addition, in different figures, identical or similar reference numerals are used to denote identical or similar elements or components.

### DETAILED DESCRIPTION OF THE INVENTION

The following description is made for the purpose of illustrating the general principles of the invention and should not be taken in a limiting sense. The scope of the invention is best determined by reference to the appended claims.

The word “embodiment” as used herein means “serving as an example, example, or illustrative.” Any embodiment described herein as “embodiment” is not necessarily to be construed as superior or superior to other embodiments.

In addition, in order to better explain the present disclosure, numerous specific details are provided in the following specific embodiments. It will be understood by those skilled in the art that the present disclosure may be practiced without certain specific details. In some instances, methods, means, components and circuits that are well known to those skilled in the art are not described in detail in order to highlight the gist of the disclosure.

To make the description of the present disclosure more detailed and complete, illustrative descriptions are provided below for the implementation aspects and specific embodiments of the present case. However, this is not the sole form of implementing or utilizing the specific embodiments of the present case. The embodiments cover the features of multiple specific embodiments as well as the method steps and their sequence for constructing and operating these specific embodiments. Nevertheless, the same or equivalent functions and sequence of steps can also be achieved using other specific embodiments.

Unless otherwise defined in this specification, the meaning of scientific and technical terms used herein is the same as commonly understood and customary by a person having ordinary skill in the art to which the present case pertains. Furthermore, without conflicting with the context, singular nouns used in this specification cover their plural forms; and plural nouns also cover their singular forms.

In some embodiments of the present disclosure, terms related to joining and connecting, such as “connect,” “interconnect,” and “bond,” unless specifically defined otherwise, may refer to situations where two structures are in direct contact, or may also refer to situations where two structures are not in direct contact, with other structures arranged between these two structures. Moreover, these terms related to connecting and joining may also include cases where both structures are movable, or both structures are fixed. Additionally, “coupled” or “connected” as used herein may refer to two or more components being in direct physical or electrical contact with each other, or indirect physical or electrical contact with each other, and may also refer to two or more components interacting or operating with each other.

Some embodiments of the present disclosure can be understood in conjunction with the drawings, and the drawings of the embodiments of the present disclosure are also considered as part of the description of the embodiments of the present disclosure. It should be understood that the drawings of the embodiments of the present disclosure are not drawn to the actual scale of devices and components. The shapes and thicknesses of the embodiments may be exaggerated in the drawings to clearly illustrate the features of the embodiments of the present disclosure. Furthermore, the structures and devices in the drawings are schematically illustrated to clearly illustrate the features of the embodiments of the present disclosure.

Herein, the term “apparatus” generally refers to an object connected in a certain way to process signals, composed of one or more transistors and/or one or more active/passive components.

Here, the terms “about,” “approximately,” and “roughly” generally indicate within 20% of a given value or range, preferably within 10%, and more preferably within 5%, or within 3%, or within 2%, or within 1%, or within 0.5%. The quantities given herein are approximate quantities, meaning that the meaning of “about,” “approximately,” or “roughly” may still be implicitly included even without specific mention of “about,” “approximately,” or “roughly”. The term “a range between a first value and a second value” means that the described range includes the first value, the second value, and other values between them. Furthermore, a certain error may exist between any two values or directions used for comparison. If the first value is equal to the second value, it implies that there may be an error of about 10%, or within 5%, or within 3%, or within 2%, or within 1%, or within 0.5% between the first value and the second value. If the first direction is perpendicular to the second direction, the angle between the first direction and the second direction may be between 80 degrees and 100 degrees. If the first direction is parallel to the second direction, the angle between the first direction and the second direction may be between 0 degrees and 10 degrees.

Certain terms will be used throughout the entire specification and claims of the present disclosure to refer to specific components. A person having ordinary skill in the art should understand that electronic device manufacturers may refer to the same components by different names. This document is not intended to distinguish between components that have the same function but different names. In the following specification and claims, terms such as “comprising” “containing” and “having” are open-ended terms, and therefore they should be interpreted as “containing but not limited to . . . ”. Thus, when the terms “comprising” “containing” and/or “having” are used in the description of the present disclosure, they specify the presence of corresponding parts, regions, steps, operations, and/or elements, but do not exclude the presence of one or more corresponding parts, regions, steps, operations, and/or elements.

It should be understood that the components from multiple different embodiments can be substituted, rearranged, and combined to complete other embodiments without departing from the spirit of the present disclosure. Components between various embodiments can be arbitrarily combined and used together, as long as they do not violate the spirit of the invention or conflict with each other.

Unless otherwise defined, all terms used herein (including technical and scientific terms) have the same meaning as commonly understood by a person having ordinary skill in the art to which the present disclosure pertains. It can be understood that these terms, for example, terms defined in commonly used dictionaries, should be interpreted as having a meaning consistent with the relevant art and the background or context of the present disclosure, and should not be interpreted in an idealized or overly formal sense, unless specifically defined in the embodiments of the present disclosure.

In the present disclosure, various directions are not limited to the three axes like the X-axis, Y-axis, and Z-axis of a Cartesian coordinate system, and can be interpreted in a broader sense. For example, the X-axis, Y-axis, and Z-axis may be perpendicular to each other, or may represent different directions that are not perpendicular to each other, but are not limited thereto. For convenience of description, hereinafter, the X-axis direction is the first direction (width direction), the Y-axis direction is the second direction (length direction), and the Z-axis direction is the third direction (thickness or height direction). In some embodiments, the cross-sectional schematic view described herein is a cross-sectional schematic view observed in the XZ plane. In some embodiments, the third direction may be the normal direction of the substrate. In some embodiments, the third direction may be the front direction of the Network design system.

In some embodiments, additional components may be added to the Network design system of the present disclosure. In some embodiments, some components of the Network design system of the present disclosure may be replaced or omitted. In some embodiments, additional operational steps may be provided before, during, and/or after the manufacturing method of the Network design system. In some embodiments, some of the described operational steps may be replaced or omitted, and the sequence of some of the described operational steps is interchangeable. Furthermore, it should be understood that some of the described steps may be replaced or deleted for other embodiments of the method. Moreover, in the present disclosure, the number and size of each component in the drawings are for illustrative purposes only, and are not intended to limit the scope of the present disclosure.

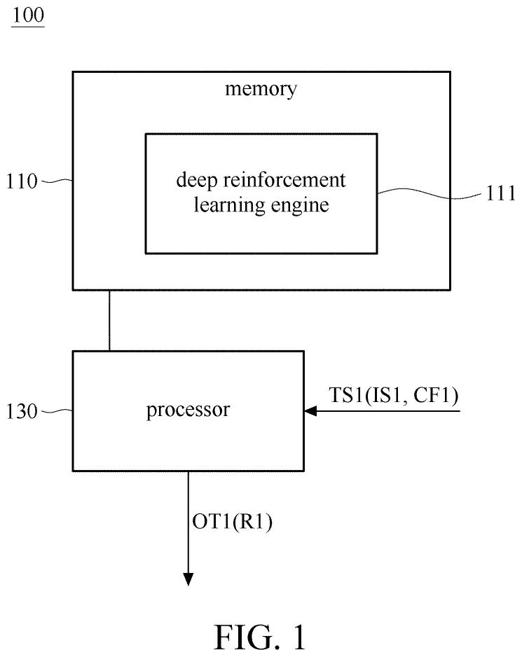

FIG. 1 is a block diagram of a network design system according to one embodiment of the present disclosure. As shown in FIG. 1, in one embodiment, the network design system 100 includes a memory 110 and a processor 130. The memory 110 is configured to store a plurality of commands and a deep reinforcement learning (DRL) engine 111.

Regarding the connection relationship, the memory 110 may be coupled to the processor 130.

In some embodiments, the memory 110 may be a random-access memory (RAM), a read-only memory (ROM), a cache, a flash memory, a memory card, a hard disk (such as a cloud/network hard disk or an external hard disk), an optical disc, a USB flash drive, or a database, among others. However, the present disclosure is not limited thereto.

In some embodiments, the plurality of commands of the memory 110 may be any type of programming language code, algorithm, software, or firmware, among others. However, the present disclosure is not limited thereto.

In some embodiments, the processor 130 may be a system-on-chip (SoC), a microprocessor unit (MPU), a central processing unit (CPU), a graphics processing unit (GPU), a microcontroller unit (MCU), a microprocessor, a digital signal processor (DSP), a field programmable gate array (FPGA), an application-specific integrated circuit (ASIC), or a server, among others. However, the present disclosure is not limited thereto.

In some embodiments, the deep reinforcement learning (DRL) engine 111 may correspond to reinforcement learning (RL) engine or model, but the present disclosure is not limited thereto.

In some embodiments, the deep reinforcement learning (DRL) engine 111 may includes a Graph Neural Network (GNN) with RL, a Graph Attention Network (GAT) with RL. For example, a graph-based RL routing model and a topology optimization RL model, but the present disclosure is not limited thereto.

In some embodiments, the deep reinforcement learning (DRL) engine 111 may be related to any type of Graph Neural Network (GNN), any type of artificial neural network (ANN) model, any type of big data algorithm, any type of machine learning algorithm, any type of artificial intelligence (AI) algorithm, or any type of Chat Generative Pre-trained Transformer (ChatGPT) algorithm, among others. However, the present disclosure is not limited thereto.

In one embodiment, the processor 130 is configured to execute following steps according to the plurality of commands of the memory 110: obtaining a plurality of topology synthesis data TS1 by the deep reinforcement learning (DRL) engine 111 according to input specification data IS1 and cost function data CF1.

For example, the input specification data IS1 may correspond to PPA-optimized Network-on-Chip (NoC) topology, the cost function data CF1 may correspond to PPA cost function, and the cost function data CF1 may be derived from the intrinsic characteristics of the NoC components and calibrated using simulation-based performance evaluations, but the present disclosure is not limited thereto.

Furthermore, the PPA may correspond to Power, Performance, and Area, but the present disclosure is not limited thereto.

In this embodiment, the processor 130 is configured to execute the following steps according to the plurality of commands of the memory 110: outputting optimized topology data OT1 through the deep reinforcement learning (DRL) engine 111 by comparing the plurality of topology synthesis data TS1.

For example, the optimized topology data OT1 may correspond to PPA-optimized NoC topology, the optimized topology data OT1 may correspond to an optimizing result of the plurality of topology synthesis data TS1, but the present disclosure is not limited thereto.

Furthermore, the optimized topology data OT1 may be the final product (or result) once training is finished and the system (such as the network design system 100) has converged, but the present disclosure is not limited thereto.

In this embodiment, the optimized topology data OT1 is related to a maximum value of reward data R1. The reward data R1 is related to the cost function data.

For example, the reward data R1 may correspond to a cost difference value of the cost function data, the optimized topology data OT1 may correspond to the maximum value of reward data R1, but the present disclosure is not limited thereto.

In this embodiment, the optimized topology data OT1 may be the final result achieved by maximizing the rewards (derived from cost differences) and minimizing the PPA cost via the cost function, but the present disclosure is not limited thereto.

In some embodiments, the network design system 100 may correspond to PPA-optimized NoC topology synthesis (system) using deep reinforcement learning and graph neural networks, but the present disclosure is not limited thereto.

In some embodiments, in the NoC topology optimization framework based on Deep Reinforcement Learning (DRL) and Graph Neural Networks (GNN), the plurality of topology synthesis data TS1 may represent all possible intermediate states and transformation processes within the optimization path.

This data encompasses dynamic topology structures, interconnect component attributes (such as clock frequencies and data widths), and routing paths. By observing these state features, which are represented as a graph and encoded with GNN, the agent performs transformation actions-such as merging or decoding communication paths-to explore the optimal design space.

Each set of synthesis data is evaluated via a PPA cost function (a formula derived from IP characteristics) to estimate PPA cost. When a topology transformation occurs, the resulting cost difference (cost diff) serves as reward data to guide the agent's learning. Through this continuous iteration and cycle of “observing, transforming, and obtaining rewards” (loop until converge), the diverse synthesis data forms the RL search space, while the cost function and reward mechanism act as core criteria to eventually filter and evolve the PPA-optimized NoC topology design, but the present disclosure is not limited thereto.

In some embodiments, the input specification data IS1 may correspond to a System-on-Chip specification (SoC Spec), the System-on-Chip specification (SoC Spec) may include various parameters used for designing and synthesizing a Network-on-Chip (NoC).

In some embodiments, the input specification data IS1 may include voltage domain information and clock frequency options, which describe the available power domains and timing configurations of different subsystems. The input specification data IS1 may further include subsystem interface locations and properties, such as communication protocols, original clock domains, and other interface-related attributes associated with the subsystems.

In addition, the input specification data IS1 may define communication requirements among subsystems, including the data transfer relationships and performance requirements for communication between different modules. The input specification data IS1 may also include available interconnect components that may be used for constructing the NoC topology, such as routers, link sizers, and clock domain converters.

Furthermore, link data width options for NoC connections may be provided, allowing different link configurations to be selected in order to satisfy various communication bandwidth and system performance requirements. These parameters collectively serve as input information for generating and optimizing the NoC topology and related communication structures, but the present disclosure is not limited thereto.

In some embodiments, the input specification data IS1 may include voltage domains and clock frequency options, subsystem interface location and properties (such as protocol, original clock domain, . . . ), communication requirements among subsystems, available interconnect components (such as router, link sizer, clock domain converter) for constructing the NoC topology, link data width options for constructing the NoC topology, but the present disclosure is not limited thereto.

In some embodiments, to estimate the PPA cost of a topology, the processor 130 may build a cost function (such as the cost function data CF1), Cost (Topology), derived from the intrinsic characteristics of the NoC components and calibrated using simulation-based performance evaluations, but the present disclosure is not limited thereto.

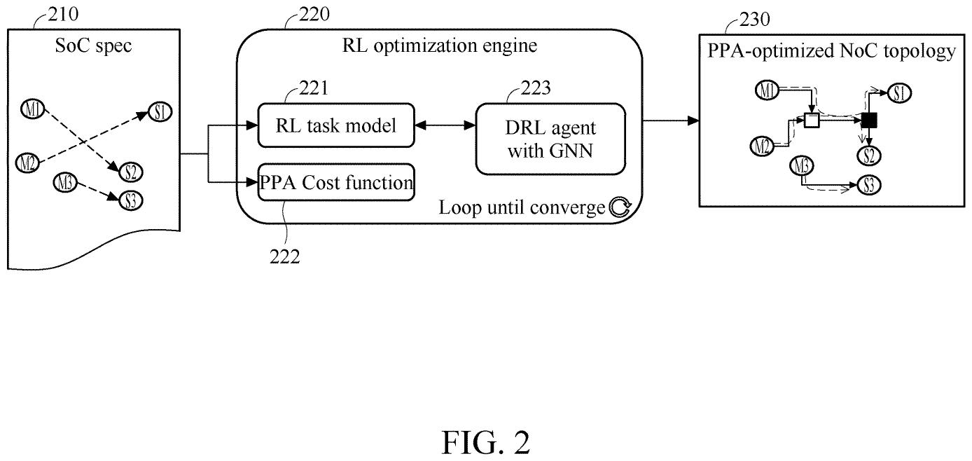

FIG. 2 is a flowchart diagram of a network design system according to one embodiment of the present disclosure. As shown in FIG. 2, in one embodiment, the flowchart 200 may include a plurality of steps 210, 220, 221, 222, 223, and 230.

Please refer to FIG. 1 and FIG. 2, the following provides a detailed description of the plurality of steps 210, 220, 221, 222, 223, and 230.

In the step 210, SoC spec.

In one embodiment, the processor 130 may map interface m1 to interface s1, the processor 130 may map interface m2 to interface s2, and the processor 130 may map interface m3 to interface s3. The SoC spec may include a plurality of subsystem interface data (such as a plurality of subsystem interfaces m1 to m3 and s1 to s3) and a plurality of communication path data.

In some embodiments, the SoC spec shown in FIG. 2 may correspond to the input specification data IS1 or the plurality of topology synthesis data TS1 shown in FIG. 1, but the present disclosure is not limited thereto.

In the step 220, RL optimization engine.

In one embodiment, the processor 130 may obtain the plurality of topology synthesis data TS1 (shown in FIG. 1) by the RL optimization engine according to the SoC spec and the PPA Cost function.

In the step 221, RL task model.

In one embodiment, the processor 130 may obtain the RL task model according to the SoC spec (or plurality of topology synthesis data TS1 shown in FIG. 1).

In the step 222, PPA Cost function.

In one embodiment, the processor 130 may obtain a result of the PPA Cost function according to the SoC spec.

In the step 223, DRL agent with GNN.

In one embodiment, the processor 130 may obtain the reward data R1 (shown in FIG. 1) by the DRL agent with GNN according to the SoC spec and the PPA Cost function.

In some embodiments, RL optimization engine shown in FIG. 2 may correspond to the deep reinforcement learning (DRL) engine 111 shown in FIG. 1, the RL task model shown in FIG. 2 may correspond to the plurality of topology synthesis data TS1 shown in FIG. 1, the PPA Cost function shown in FIG. 2 may correspond to the cost function data CF1 shown in FIG. 1, but the present disclosure is not limited thereto.

In some embodiments, the processor 130 may iteratively perform (loop) the plurality of steps 221 to 223 until convergence is achieved, but the present disclosure is not limited thereto.

In the step 230, PPA-optimized NoC topology.

In one embodiment, the processor 130 may output the PPA-optimized NoC topology through the RL optimization engine by comparing the plurality of topology synthesis data TS1 (shown in FIG. 1).

In some embodiments, the PPA-optimized NoC topology shown in FIG. 2 may correspond to the optimized topology data OT1 shown in FIG. 1, but the present disclosure is not limited thereto.

Please refer to the plurality of steps 210, 220, 221, 222, 223, and 230. In one embodiment, the processor 130 executes the following steps according to the plurality of commands of the memory 110: formulating one of the plurality of topology synthesis data TS1 as a reinforcement learning (RL) task data by the deep reinforcement learning (DRL) engine 111; and jointly optimizing the topology synthesis data, clock config data, data-width config data, and routing path data according to the reinforcement learning (RL) task data.

For example, the reinforcement learning (RL) task data may correspond to the RL task model, the processor 130 may obtain the RL task model based on the SoC spec (or the topology synthesis data). The processor 130 may jointly optimizes the topology synthesis data, the clock config data, the data-width config data, and the routing path data by the RL task model, but the present disclosure is not limited thereto.

In some embodiments, the expression “data-width config data” may be adopted to prevent the term “width” from being interpreted as referring only to a physical line width, and to clarify that it denotes a bit-width of data, but the present disclosure is not limited thereto.

In some embodiments, the plurality of topology synthesis data TS1 may jointly optimizes the topology synthesis data with the SoC spec, but the present disclosure is not limited thereto.

In one embodiment, the reinforcement learning (RL) task data is related to a topology transformation data.

For example, the reinforcement learning (RL) task data may transform the topology synthesis data to the reward data R1 shown in FIG. 1, but the present disclosure is not limited thereto.

In one embodiment, the processor 130 executes the following steps according to the plurality of commands of the memory 110: encoding dynamic topology state data as graph data by reinforcement learning agent with graph neural network data according to the reinforcement learning (RL) task data; and obtaining a value of the cost function data by the deep reinforcement learning (DRL) engine 111 according to the graph data.

For example, the reinforcement learning agent with graph neural network data may correspond to the DRL agent with GNN, and the processor 130 may encode the dynamic topology state as the graph (or image) by the DRL agent with GNN based on the RL task model. The processor 130 may obtain the value of the PPA cost function of the graph by the RL optimization engine, but the present disclosure is not limited thereto.

In one embodiment, the reinforcement learning agent is related to the deep reinforcement learning (DRL) engine 111. The graph neural network data is related to the deep reinforcement learning (DRL) engine 111. The graph data is related to one of the plurality of topology synthesis data. The one of the plurality of topology synthesis data corresponds to end-to-end topology data.

For example, the deep reinforcement learning (DRL) engine 111 may include the reinforcement learning agent and the graph neural network data, the graph may correspond to the topology synthesis, and the topology synthesis may correspond to the end-to-end topology, but the present disclosure is not limited thereto.

Furthermore, the end-to-end topology data may correspond to an end-to-end topology synthesis, the end-to-end topology synthesis may imply integrating traditionally fragmented design tasks (such as the topology structure design, the attribute configuration (such as clock and data width), and the routing path planning) into an unified RL optimization engine. This enables a complete automated workflow that transforms the SoC specifications into the PPA-optimized NoC topology, but the present disclosure is not limited thereto.

In some embodiments, the processor 130 may adopt GNN to encode the dynamic topology states, enabling method (the flowchart 200) to generalize to SoC designs with varying complexity, but the present disclosure is not limited thereto.

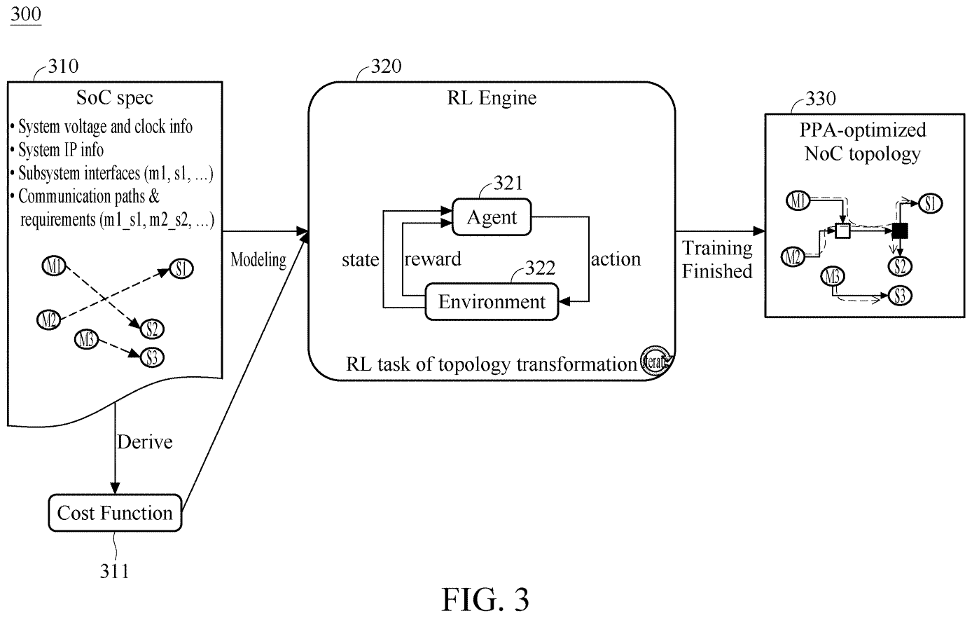

FIG. 3 is a flowchart diagram of a network design system according to one embodiment of the present disclosure. As shown in FIG. 3, in one embodiment, the flowchart 300 may include a plurality of steps 310, 311, 320, 321, 322, and 330.

Please refer to FIG. 1 and FIG. 3, the following provides a detailed description of the plurality of steps 310, 311, 320, 321, 322, and 330.

In the step 310, SoC spec.

In one embodiment, the SoC spec may include the system voltage information, the system clock information, the system Intellectual Property (IP) information, the subsystem interfaces, the communication paths and requirements.

In some embodiments, the step 310 shown in FIG. 3 may correspond to the step 210 shown in FIG. 2, but the present disclosure is not limited thereto.

In the step 311, Cost Function.

In one embodiment, the processor 130 may obtain a result of the Cost Function according to the SoC spec. The Cost Function may derive from the SoC spec.

In some embodiments, the step 311 shown in FIG. 3 may correspond to the step 222 shown in FIG. 2, but the present disclosure is not limited thereto.

In the step 320, RL engine.

In one embodiment, the processor 130 may obtain the plurality of topology synthesis data TS1 (shown in FIG. 1) by the RL engine according to the SoC spec and the Cost Function.

In some embodiments, the step 320 shown in FIG. 3 may correspond to the step 220 shown in FIG. 2, but the present disclosure is not limited thereto.

In some embodiments, the RL engine may include action (data), the state (data), and reward (data), but the present disclosure is not limited thereto.

In some embodiments, the action (data) shown in FIG. 3 may be related to the plurality of topology synthesis data TS1 shown in FIG. 1, the state (data) shown in FIG. 3 may be related to the plurality of topology synthesis data TS1 shown in FIG. 1, and reward (data) shown in FIG. 3 may correspond to the reward data R1 shown in FIG. 1, but the present disclosure is not limited thereto.

In the step 321, Agent.

In one embodiment, the processor 130 may obtain the reward data R1 (shown in FIG. 1) by the agent according to the SoC spec and the Cost Function.

In some embodiments, the step 321 shown in FIG. 3 may correspond to the step 220 shown in FIG. 2, but the present disclosure is not limited thereto.

In the step 321, Environment.

In one embodiment, the Environment may receive the action (data), the Environment may output the state (data), and the Environment may output the reward (data).

In some embodiments, in a reinforcement learning (RL) framework, the Environment may be a core component that represents the space in which an agent interacts and performs optimization operations.

In some embodiments, the Environment is configured to receive actions executed by the agent and update the system state (such as the state data) accordingly.

For example, when the agent modifies the topology structure, routing paths, or configuration attributes by merging or decoding communication paths, these actions are applied to the Environment, thereby updating the current topology model.

The Environment may also provide state feedback to the agent. Such state data may include information related to the current topology structure, topology attributes (such as clock frequency and data width configuration parameters), and routing path status.

In addition, the Environment may generate corresponding reward data based on the outcome of the actions executed by the agent. For instance, the reward may be determined according to the change in the power, performance, and area (PPA) cost of the topology, such as a calculated cost difference reflecting the impact of the action on the design quality.

Through these mechanisms, the Environment may embody the reinforcement learning task model, such as a topology transformation task, and is responsible for maintaining the dynamic evolution and state transition process from an initial system-on-chip (SoC) specification to a final PPA-optimized topology, but the present disclosure is not limited thereto.

In some embodiments, the Environment shown in FIG. 3 may be related to the plurality of topology synthesis data TS1 shown in FIG. 1, but the present disclosure is not limited thereto.

Please refer to the plurality of steps 320 to 322. In one embodiment, in each episode (or iteration), the agent may conduct a sequence of actions to transform the topology (such as one of the plurality of topology synthesis data TS1).

In some embodiments, the state (data) may include current topology data, topo attribute data, and routing path status data, but the present disclosure is not limited thereto.

In some embodiments, the agent performs actions such as merging or decoding communication paths to modify the current network design. Through these actions, the agent may change the topology structure, adjust routing paths, and configure topology attributes (suac as clock frequency, data width, or other related parameters), thereby updating the overall NoC configuration and influencing the resulting system design, but the present disclosure is not limited thereto.

In some embodiments, the action may jointly optimize sub-problems in NoC topology synthesis, but the present disclosure is not limited thereto.

In some embodiments, the reward may correspond to topo PPA cost change, but the present disclosure is not limited thereto.

In some embodiments, the task objective may be to optimize the PPA Cost of NoC topology. To guide the agent toward achieving this goal, the system (such as the network design system 100) may define the topo PPA cost change as the reward within the reinforcement learning framework (such as the RL Engine), but the present disclosure is not limited thereto.

In the step 330, PPA-optimized NoC topology.

In one embodiment, the RL engine may output the PPA-optimized NoC topology according to the SoC Spec and the Cost Function.

In some embodiments, the step 330 shown in FIG. 3 may correspond to the step 230 shown in FIG. 2, but the present disclosure is not limited thereto.

Please refer to the plurality of steps 310, 311, 320, 321, 322, and 330. In one embodiment, the processor 130 executes the following steps according to the plurality of commands of the memory 110: obtaining first topology state data by the reinforcement learning agent; observing first current topology data of the first topology state data by the reinforcement learning agent; transforming first topology structure data of the plurality of topology synthesis data TS1 by the reinforcement learning agent; and obtaining a first difference value of the cost function data CF1 as the reward data R1.

For example, the reinforcement learning agent may correspond to the DRL agent with GNN or the agent, but the present disclosure is not limited thereto.

In this embodiment, the processor 130 executes the following steps according to the plurality of commands of the memory 110: obtaining second topology state data by the reinforcement learning agent; observing second current topology data of the second topology state data by the reinforcement learning agent; transforming second topology structure data of the plurality of topology synthesis data TS1 by the reinforcement learning agent; obtaining a second difference value of the cost function data CF1 as the reward data R1; and outputting the optimized topology data OT1 through the deep reinforcement learning (DRL) engine 111 according to the reward data R1.

In this embodiment, the first topology state data and the second topology state data are related to the plurality of topology synthesis data TS1. The first current topology data and the second current topology data are related to the plurality of topology synthesis data TS1.

For example, during the different state (such as the first topology state data or the second topology state data), the second topology state (data) may be after the first topology state (data), and the first current topology data and the second current topology data are different from each other, but the present disclosure is not limited thereto.

In some embodiments, the first difference value of the cost function data and the second difference value of the cost function data may be related to the value of the cost function data, but the present disclosure is not limited thereto.

In some embodiments, the value of the cost function data may refer to the absolute estimated PPA cost at a specific state, which is calculated using a formula derived from the intrinsic characteristics of NoC components (such as IP characteristics, clock info, and voltage domains). The value of the cost function data may represent the total cost of the topology scheme in terms of power, performance, and area (PPA), but the present disclosure is not limited thereto.

In some embodiments, the first difference value of the cost function data (or the second difference value of the cost function data) may be the cost variation (Cost diff) between two successive states after the agent executes an action, reflecting the “cost reduction” achieved by the operation.

In the RL engine (such as the deep reinforcement learning (DRL) engine 111), the first difference value of the cost function data (or the second difference value of the cost function data) may be explicitly defined as reward data that serves as a score for the agent's optimization effectiveness.

This reward (such as the reward data R1) guides the agent through a continuous cycle of “observing the state->transforming the topology->obtaining a reward,” allowing it to eventually learn how to transform an initial design into a PPA-optimized NoC topology, but the present disclosure is not limited thereto.

In some embodiments, the core learning logic of the network design system 100 may be established within a reinforcement learning loop. First, the agent observes the dynamic topology state via GNN, where the state feature is represented as a graph. This state encompasses the current topology, topo attributes, and routing path status.

Next, the agent conducts transformation actions-such as merging or decoding communication paths-to actively change the topology structure, change routing paths, and config topology attributes. Subsequently, the network design system 100 may utilize the PPA cost function (a derived formula based on IP characteristics) to calculate the resulting cost diff (cost difference), which is provided to the agent as a reward. Through continuous iterations and training, the RL agent learns how to transform the topology into a final PPA-optimized NoC topology), but the present disclosure is not limited thereto.

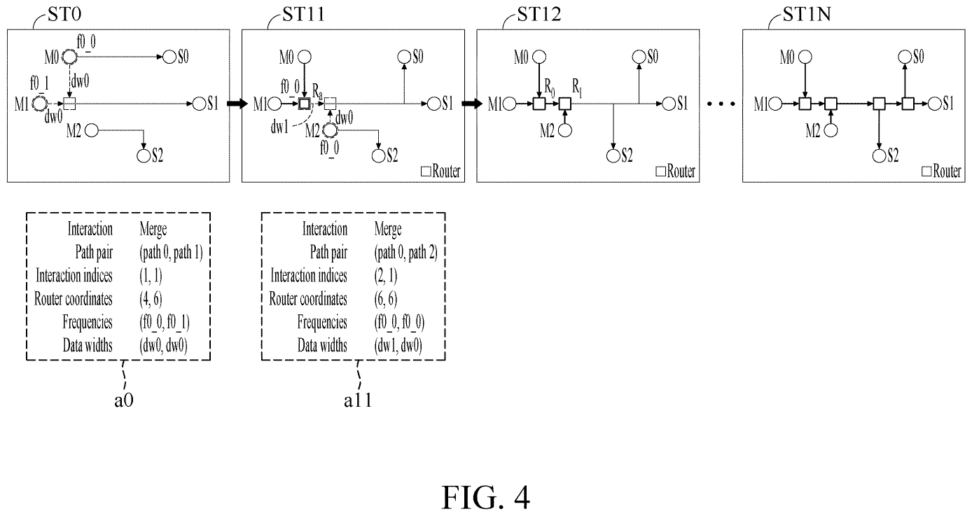

FIG. 4 is a flowchart diagram of a network design system according to one embodiment of the present disclosure. As shown in FIG. 4, in one embodiment, the flowchart 400 may include a plurality topology data STO, ST11, ST12 to STIN.

In some embodiments, the flowchart 400 may correspond to a first episode, but the present disclosure is not limited thereto.

In some embodiments, the topology data STO may correspond to initial state at initial time, the topology data ST11 may correspond to first state at first time, the topology data ST12 may correspond to second state at second time, and the topology data STIN may correspond to N state at N time, but the present disclosure is not limited thereto.

In some embodiments, the topology data STO may correspond to initial action a0 at initial time, the topology data ST11 may correspond to first action a11 at first time, but the present disclosure is not limited thereto.

In some embodiments, the topology data STO may correspond to initial cost topology value, the topology data ST11 may correspond to first cost topology value, the topology data ST12 may correspond to second cost topology value, and the topology data STIN may correspond to N cost topology value, but the present disclosure is not limited thereto.

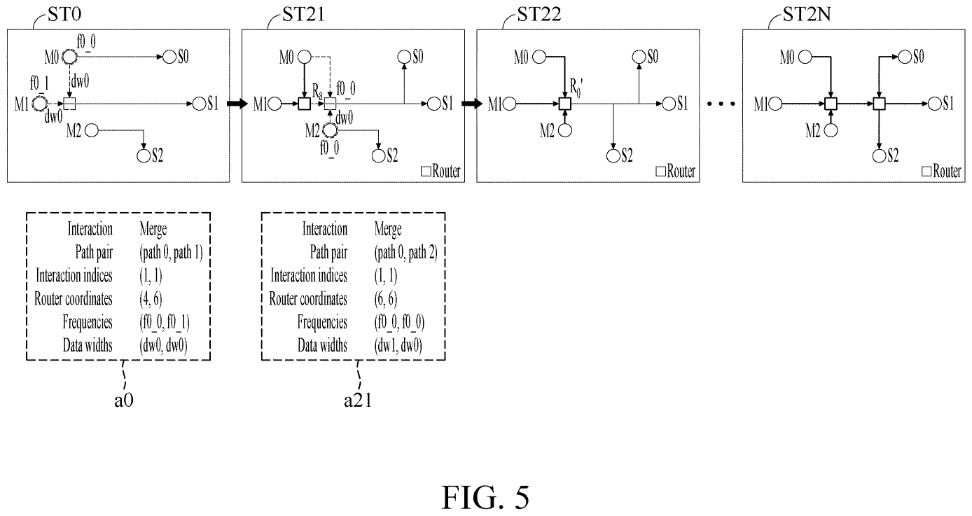

FIG. 5 is a flowchart diagram of a network design system according to one embodiment of the present disclosure. As shown in FIG. 5, in one embodiment, the flowchart 500 may include a plurality topology data STO, ST21, ST22 to ST2N.

In some embodiments, the flowchart 500 may correspond to a first episode, but the present disclosure is not limited thereto.

In some embodiments, the topology data STO may correspond to initial state at initial time, the topology data ST21 may correspond to first state at first time, the topology data ST22 may correspond to second state at second time, and the topology data ST2N may correspond to N state at N time, but the present disclosure is not limited thereto.

In some embodiments, the topology data STO may correspond to initial action a0 at initial time, the topology data ST21 may correspond to first action a21 at first time, but the present disclosure is not limited thereto.

In some embodiments, the topology data STO may correspond to initial cost topology value, the topology data ST21 may correspond to first cost topology value, the topology data ST22 may correspond to second cost topology value, and the topology data ST2N may correspond to N cost topology value, but the present disclosure is not limited thereto.

Please refer to FIG. 1, FIG. 4, and FIG. 5. In one embodiment, the processor 130 may define the reward at each step as the reduction in estimated PPA cost (using the derived Cost (Topology)) after applying the action, and the reward may fit the following Formula 1.

r(st,at)=Cost(Topologyt)−Cost(Topologyt+1) Formula 1.

As described above, the parameter r(st, at) may represent to the reward, the parameter st may represent to state at time t, the parameter at may c represent to action at time t, the parameter Cost(Topologyt) may represent to the estimated PPA cost of the current NoC topology at time t (current step), the parameter Cost(Topologyₜ₊₁) may represent to the estimated PPA cost of the new topology at time t+1 (the next step), but the present disclosure is not limited thereto.

In some embodiments, the parameter r(st, at) may correspond to the reward data R1 shown in FIG. 1, the parameter Cost(Topologyt) may correspond to the cost function data CF1 shown in FIG. 1, the parameter Cost(Topologyt+1) may correspond to the cost function data CF1 shown in FIG. 1), but the present disclosure is not limited thereto.

In some embodiments, the processor 130 shown in FIG. 1 may output the topology data ST2N while the reward is maximum value. The reward is the difference value between the initial cost topology value and the N cost topology value, but the present disclosure is not limited thereto.

In some embodiments, in the previous example episodes, the number of intermediate routers and links in the topology is not fixed across different states. This poses a challenge for designing a compact and informative state representation that may be efficiently consumed by the RL agent.

Therefore, the processor 130 may design a path-centric graph abstraction that captures the evolving topology and routing configurations in a compact, fixed-size form. To extract meaningful embeddings from this structure, the processor 130 may apply a graph neural network (GNN) over the path-centric graph, but the present disclosure is not limited thereto.

Please refer to FIG. 1 to FIG. 5. In one embodiment, the network design system 100 may utilize the reinforcement learning (RL) framework (such as the deep reinforcement learning (DRL) engine 111) to transform complex chip design tasks into a “game” where an Artificial Intelligence (AI) practices achieving optimal designs through sequences of actions.

In this game, the DRL agent acts as a player, operating within the topology synthesis space known as the environment. The player observes the current topology state the “game situation” which includes the topology structure, attribute configurations, and routing paths-via GNN, and executes actions (functioning like game commands) such as merging or decoding communication paths to modify the design structure.

After each operation, the network design system 100 may utilize a PPA cost function to calculate the resulting cost diff and provides it to the player as a reward; much like a game score, this reward guides the agent to evolve toward minimizing PPA costs. Through continuous iterations and “replays” across multiple episodes, the agent eventually learns how to transform an initial design into a PPA-optimized NoC topology, but the present disclosure is not limited thereto.

In one embodiment, the topology synthesis data TS1 is related to a Markov decision process (MDP). The deep reinforcement learning (DRL) engine 111 includes graph neural network data and deep q-network data. The plurality of topology synthesis data TS1 are related to joint topology construction data, topology attribute data, and routing path data.

For example, the deep q-network (DQN) data may correspond to the reinforcement learning agent, the DRL agent shown in FIG. 2, or the agent shown in FIG. 3, but the present disclosure is not limited thereto.

Furthermore, the graph neural network data and the deep q-network data may the DRL agent with GNN shown in FIG. 2, but the present disclosure is not limited thereto.

In some embodiments, the joint topology construction data may correspond to the topology structure design, the topology structure, the topology structure, or the current topology structure, but the present disclosure is not limited thereto.

In some embodiments, the topology attribute data may correspond to the configuration attributes or the topology attributes (such as clock frequency and data width configuration parameters), but the present disclosure is not limited thereto.

In some embodiments, the routing path data may correspond to the routing paths, communication paths, or the routing path status data, but the present disclosure is not limited thereto.

In some embodiments, the Markov Decision Process (MDP) may serve as the core mathematical framework for transforming the NoC topology synthesis task into a reinforcement learning (RL) problem, and the agent may gradually optimize the initial design into a final result over a series of sequential decision steps, but the present disclosure is not limited thereto.

In some embodiments, the processor 130 may formulate topology synthesis as a Markov decision process (MDP) where the RL agent transforms the topology step-by-step by modifying routing paths and updating the topology accordingly, but the present disclosure is not limited thereto.

In some embodiments, the initial state of the MDP is derived directly from the input traffic specifications. At the beginning of each episode, the topology is initialized as a fully point-to-point structure in which each communication path routes directly from its master to its slave with no shared physical links with others.

The communication path is defined by a source interface (master) and a destination interface (slave) if there are communication requirements between them, but the present disclosure is not limited thereto.

In some embodiments, each action encapsulates a change in the routing paths of the chosen communication paths, and the corresponding transformation of the current topology along with the configurations of the node/link attributes of the transformed part. The complete action is defined as follows:

action = {
“interaction”: “merge” or “decode”
“path pair” : (path_i, path_j),
“interaction indices”: (idx_i, idx
“router coordinates” : (x, y),
“frequencies”: (f_i, f_j),
“data widths”: (dw_i, dw_j),
}

In one embodiment, the topology synthesis data TS1 is related to a network-on-chip (NoC) data.

For example, the topology synthesis may be related to the network-on-chip (NoC) technology, but the present disclosure is not limited thereto.

In some embodiments, the topology synthesis data TS1 may correspond to a topology synthesis, but the present disclosure is not limited thereto.

In some embodiments, the topology synthesis data TS1 may correspond to a topology pattern graph, but the present disclosure is not limited thereto.

In one embodiment, the processor 130 executes the following steps according to the plurality of commands of the memory 110: modifying communication path data to minimize power data and area data by reinforcement learning agent while meeting performance constraint data.

For example, the communication path data may correspond to the communication paths, the performance constraint data may correspond to the system performance requirements, but the present disclosure is not limited thereto.

Furthermore, the communication path data may be related to the communication protocols, the communication bandwidth, or the communication requirements among subsystems, but the present disclosure is not limited thereto.

In some embodiments, the processor 130 may modify the communication path data to minimize the power, performance, and area (PPA) by the reinforcement learning agent while meeting the performance constraint data, but the present disclosure is not limited thereto.

In some embodiments, the processor 130 may modify the communication path data to minimize the power, performance, and area (PPA) cost of the topology by the reinforcement learning agent while meeting the performance constraint data, but the present disclosure is not limited thereto.

In one embodiment, the cost function data CF1 includes the power data and the area data. The communication path data is related to the routing path data. The deep reinforcement learning (DRL) engine 111 includes the reinforcement learning agent.

For example, the cost function data CF1 may include at least one of the power, performance, and area (PPA), but the present disclosure is not limited thereto.

Furthermore, the cost function data CF1 may include the parameter Cost(Topologyt) and the parameter Cost(Topologyt+1), but the present disclosure is not limited thereto.

In one embodiment, the processor 130 executes the following steps according to the plurality of commands of the memory 110: optimizing topology data through the reinforcement learning agent by merging or decoding the communication path data.

In one embodiment, the topology data is related to the optimized topology data OT1.

For example, the topology data may correspond to the topology pattern, but the present disclosure is not limited thereto.

In one embodiment, the processor 130 executes the following steps according to the plurality of commands of the memory 110: optimizing the topology data through the reinforcement learning agent by assigning a plurality of attribute data to the topology data.

In one embodiment, the plurality of attribute data includes clock config data and data-width config data.

For example, the plurality of attribute data may include the configuration attributes and the topology attributes (such as clock frequency and data width configuration parameters), but the present disclosure is not limited thereto.

In one embodiment, the processor 130 executes the following steps according to the plurality of commands of the memory 110: encoding topology state data by the graph neural network data while optimizing the topology data.

For example, the topology state data may correspond to the parameter st or the dynamic topology state, but the present disclosure is not limited thereto.

In one embodiment, the topology state data is related to the topology data. The topology state data includes current topology data, the plurality of attribute data, routing path status data. The routing path status data is related to the routing path data. The topology state data correspond to state feature data and graph data.

For example, the state feature data may include dynamic topology structures, interconnect component attributes (such as clock frequencies and data widths), and routing paths, but the present disclosure is not limited thereto.

In one embodiment, the processor 130 executes the following steps according to the plurality of commands of the memory 110: obtaining the input specification data IS1 by an input interface; and verifying and outputting the optimized topology data OT1 by an output module.

In one embodiment, the network design system 100 further includes the input interface and the output module.

In one embodiment, the processor 130 executes the following steps according to the plurality of commands of the memory 110: jointly optimizing at least one of protocol data, link type data, voltage data, and custom attribute data according to the reinforcement learning (RL) task data; and jointly optimizing Network-on-Chip (NoC) topology design dimension data according to the reinforcement learning (RL) task data.

In one embodiment, the plurality of topology synthesis data TS1 comprise at least one of the protocol data, the link type data, the voltage data, and the custom attribute data.

In one embodiment, the protocol data, the link type data, the voltage data, and the custom attribute data are related to the cost function data CF1.

In one embodiment, the Network-on-Chip (NoC) topology design dimension data is related to one of the plurality of topology synthesis data.

In some embodiments, operations related to jointly optimizing multiple parameters (or data) may correspond to a joint optimization mechanism, but the present disclosure is not limited thereto.

In some embodiments, the joint optimization mechanism may be extended to other Network-on-Chip (NoC) topology design dimensions, such as protocol, link type, voltage, and other customizable attributes.

As long as the NoC topology design dimensions may be quantified through a cost function (such as the cost function data), the NoC topology design dimensions may be incorporated into the same reinforcement learning (RL) and graph neural network (GNN) framework (such as the deep reinforcement learning (DRL) engine 111) for optimization, but the present disclosure is not limited thereto.

In some embodiments, the input interface may include Master interfaces, such as the processors, the GPU, the Direct Memory Access (DMA) Controller, or the System IP, but the present disclosure is not limited thereto.

In some embodiments, the output module may include Slave interfaces, such as the Memory Controllers, the Storage/Memory, or the Peripherals, but the present disclosure is not limited thereto.

In some embodiments, the input interface and the output module may be the subsystem interfaces, but the present disclosure is not limited thereto.

In some embodiments, the overall training procedure of the proposed RL framework is summarized in Algorithm 1.

The Algorithm 1 is defined as follows:

Algorithm 1. DRL-Based Topology Synthesis Framework.

| Require: SoC input specification, cost function Cost (−) | |
|---|---|
| for PPA estimation | |
| Ensure: Synthesized topology minimizing FFA cost | |
| 1 : | Initialize Q-network Q_{θ} and target network Q_{θ}- |
| 2 : | Initialize replay buffer D |
| 3 : | for episode = 1 to T do |
| 4 : | Initialize state S0 from input (point-to-point |
| topology) | |
| 5 : | for t. = 0 to T do |
| 6 : | Construct path relationship graph Gt from st |
| 7 : | Encode Gt using GNN to obtain : |
| 8 : | Vertex embeddings { h1, . . . , hn } |
| 9 : | Global embedding gt |
| 10 : | Select action at using ϵ-greedy policy from |
| | Q_{θ}( st, at ) |
| 11 : | Apply at to environment : |
| 12 : | Modify routing and topology |
| 13 : | Update node/link attributes in the topology |
| 14 : | Compute reward rt = Cost(st) − Cost( .st+i ) |
| 15 : | Observe next state st+1 |
| 16 : | Store transition (st, at, rt, st+1) in buffer D |
| 17 : | Sample mini-batch from D |
| 18 : | Update Q_{θ} using TD-loss : |
| | L = (r + γ × maxQ_{θ}_(st, α) − Q_{θ}(st, αt))² |
| 19 : | if time to update target network then |
| 20 : | Q_{θ}- ← Q_{θ} |
| 21 : | end if |
| 22 : | end for |
| 23 : | Record final state .st+1 and corresponding PPA |
| cost | |
| 24 : | end for |
| 25 : | return topology from episode with lowest PPA |

cost

In some embodiments, the core function of the action is to determine a pairwise interaction between two communication paths at each decision step. The topology and the routing paths are then transformed accordingly, but the present disclosure is not limited thereto.

In one embodiment, upon convergence, the network design system 100 outputs a synthesized NoC topology comprising routers, links, assigned frequencies, and data widths, ensuring all communication requirements are met with minimized area and power, but the present disclosure is not limited thereto.

In some embodiments, in conventional network-on-chip (NoC) synthesis technologies, the design flow generally follows a segmented or stage-based optimization methodology, in which the overall synthesis problem is decomposed into multiple relatively independent subproblems that are addressed sequentially rather than optimized in an integrated manner.

Under such a design paradigm, the construction of the network topology, the configuration of clock parameters and communication characteristics (such as data width or bandwidth), and the determination or planning of routing paths are typically treated as separate and largely independent stages within the overall design process.

As a consequence, decisions made in one stage are often determined without full awareness of the constraints or optimization opportunities present in other stages, which may limit the ability of the overall system to achieve globally optimal performance in terms of latency, throughput, power consumption, or hardware resource utilization.

Furthermore, many existing NoC synthesis techniques are implemented using non-end-to-end design frameworks, in which the transformation from an initial system-on-chip (SoC) specification to a final network architecture or implementation involves multiple intermediate representations, iterative refinement steps, or transitions between different design tools and toolchains.

In such conventional workflows, designers frequently need to manually coordinate the outputs of different stages or tools to ensure consistency across the design process. As a result, the design procedure often relies heavily on the experience and domain knowledge of engineers, and various design decisions are guided or constrained by predefined heuristic rules or manually tuned parameters. Although such heuristic-based approaches may provide practical solutions under certain conditions, they generally lack the capability to perform automated global optimization across multiple design dimensions.

In addition, these approaches typically do not provide mechanisms for adaptive learning or data-driven improvement during the synthesis process, thereby limiting the degree of automation and scalability that can be achieved in modern large-scale SoC designs that incorporate increasingly complex on-chip communication requirements. However, the present disclosure is not limited thereto.

In some embodiments, compared with conventional techniques, the network design system 100 of the present disclosure may achieves significant advancements and improvements in NoC topology synthesis by the reinforcement learning (RL) framework (such as the deep reinforcement learning (DRL) engine 111), but the present disclosure is not limited thereto.

In some embodiments, the network design system 100 of the present disclosure may shift from “segmented” to “Joint Optimization”. Conventional technologies treat topology construction, clock configuration, and routing path planning as independent stages, which often misses the global optimum.

The network design system 100 may provide the first unified framework for the joint optimization of topology, clock and data width configurations, and routing. This integrated approach breaks the information barriers between stages, achieving superior global performance optimization), but the present disclosure is not limited thereto.

In some embodiments, the network design system 100 of the present disclosure may achieve “End-to-End” automated synthesis. Unlike conventional workflows that require designers to manually coordinate multiple intermediate tools and steps, the network design system 100 may utilize Deep Reinforcement Learning (DRL) and Graph Neural Network (GNN) to solve the end-to-end topology synthesis problem. This significantly reduces reliance on engineers' domain knowledge and manually tuned heuristic rules, thereby enhancing design efficiency, but the present disclosure is not limited thereto.

In some embodiments, the network design system 100 of the present disclosure may enhanced “Scalability” and generalization capability. Traditional heuristic rules struggle to handle increasingly complex SoC designs, the network design system 100 may adopt GNN to encode dynamic topology states, enabling the system to process SoC designs with varying complexity and demonstrating stronger generalization and adaptability, but the present disclosure is not limited thereto.

In some embodiments, the network design system 100 of the present disclosure may achieve “PPA-optimized” results through data-driven methods (such as the flowchart 200 and the flowchart 300). The network design system 100 may model the optimization task as an RL task (or MDP loop), utilizing a PPA Cost function to accurately estimate power, performance, and area costs, which is then converted into a reward mechanism.

Through continuous “replays” and learning across multiple episodes, the agent eventually produces NoC topologies that are more precise and PPA-optimized compared to traditional heuristic-based methods, but the present disclosure is not limited thereto.

In some embodiments, the network design system 100 of the present disclosure may transform fragmented and manual design processes into a highly automated, data-driven framework capable of joint optimization across multiple dimensions and handling complex designs, ultimately achieving superior overall system performance, but the present disclosure is not limited thereto.

In some embodiments, the network design system 100 of the present disclosure may present a novel deep reinforcement learning (DRL)-based framework with graph neural networks (GNNs) for automatic network-on-chip (NoC) topology synthesis in system-on-chips (SoCs). The network design system 100 formulates topology synthesis as an RL task, which enables joint optimization of key sub-problems including topology generation, clock frequency and data width configuration, and routing decision.

This joint formulation allows RL agent to make globally informed decisions throughout the synthesis process, effectively reducing the risk of obtaining sub-optimal solutions that may arise when these sub-problems are optimized in separate stages. To represent dynamically evolving topologies during optimization, the network design system 100 may employ a graph-based encoding with GNNs to achieve expressive and static state representations. The use of GNNs further enables the method to scale effectively across designs with varying complexity.

The network design system 100 may evaluate the method on real-world SoC designs with diverse communication requirements. The results show that the method achieves above 30% reduction in area and power cost compared to human-tuned topologies, all while meeting performance constraints.

These improvements highlight the capability of RL to explore vast design spaces for PPA optimization. This work pioneers the use of RL in combination with GNNs for topology synthesis, offering a unified framework for optimizing modern SoC communication networks, but the present disclosure is not limited thereto.

In some embodiments, a step described herein as being performed “by” a module, engine, data, or other processing entity may alternatively be performed by a processor or controller “using” such module, engine, data, or processing entity.

For example, the processor may control, instruct, or utilize the module to perform the step, such that references to steps performed “by” the module are considered to include steps performed “using” the module by the processor. Accordingly, any step described herein as performed “by” a component may equivalently be understood as performed “using” that component under the control of a processor or similar control entity.

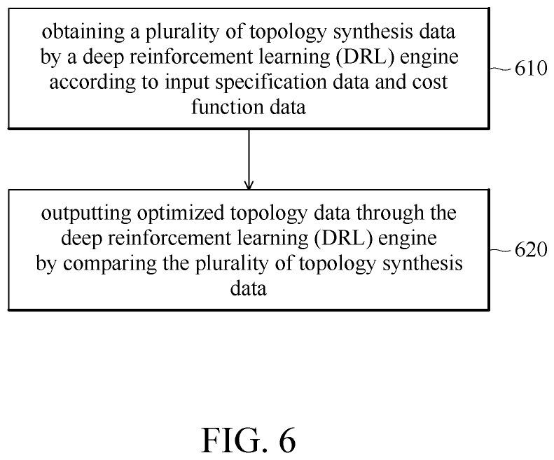

FIG. 6 is a schematic flowchart of a network design method according to one embodiment of the present disclosure. As shown in FIG. 6, in one embodiment, the network design method 600 may include the plurality of steps 610 to 620.

Please refer to FIG. 1 to FIG. 6, the following provides a detailed description of the plurality of steps 610 to 620.

In the step 610, obtaining a plurality of topology synthesis data by a deep reinforcement learning (DRL) engine according to input specification data and cost function data.

In one embodiment, the processor 130 may obtain the plurality of topology synthesis data TS1 by the deep reinforcement learning (DRL) engine 111 according to the input specification data IS1 and the cost function data CF1.

In the step 620, outputting optimized topology data through the deep reinforcement learning (DRL) engine by comparing the plurality of topology synthesis data.

In one embodiment, the processor 130 may output optimized topology data OT1 through the deep reinforcement learning (DRL) engine 111 by comparing the plurality of topology synthesis data TS1.

In one embodiment, the optimized topology data OT1 is related to the maximum value of reward data R1. The reward data R1 is related to the cost function data CF1.

It should be understood that the above steps need not be performed sequentially, and each feature of the embodiments shown in FIG. 1 to FIG. 5 may be applied to the the network design method 600 illustrated in FIG. 6.

In one embodiment, the network design method 600 further includes the following steps: formulating one of the plurality of topology synthesis data TS1 as a reinforcement learning (RL) task data by the deep reinforcement learning (DRL) engine 111; and jointly optimizing the topology synthesis data TS1, clock config data, data-width config data, and routing path data according to the reinforcement learning (RL) task data.

In one embodiment, the reinforcement learning (RL) task data is related to a topology transformation data.

In one embodiment, the network design method 600 further includes the following steps: encoding dynamic topology state data as graph data by reinforcement learning agent with graph neural network data according to the reinforcement learning (RL) task data; and obtaining a value of the cost function data CF1 by the deep reinforcement learning (DRL) engine 111 according to the graph data.

In one embodiment, the reinforcement learning agent is related to the deep reinforcement learning (DRL) engine 111. The graph neural network data is related to the deep reinforcement learning (DRL) engine 111. The graph data is related to one of the plurality of topology synthesis data TS1. One of the plurality of topology synthesis data TS1 corresponds to end-to-end topology data.

In one embodiment, the network design method 600 further includes the following steps: obtaining first topology state data by the reinforcement learning agent; observing first current topology data of the first topology state data by the reinforcement learning agent; transforming first topology structure data of the plurality of topology synthesis data TS1 by the reinforcement learning agent; obtaining a first difference value of the cost function data CF1 as the reward data R1; obtaining second topology state data by the reinforcement learning agent; observing second current topology data of the second topology state data by the reinforcement learning agent; transforming second topology structure data of the plurality of topology synthesis data TS1 by the reinforcement learning agent; obtaining a second difference value of the cost function data CF1 as the reward data R1; and outputting the optimized topology data OT1 through the deep reinforcement learning (DRL) engine 111 according to the reward data R1.

In one embodiment, the first topology state data and the second topology state data are related to the plurality of topology synthesis data TS1. The first current topology data and the second current topology data are related to the plurality of topology synthesis data TS1.

In one embodiment, the topology synthesis data TS1 is related to a Markov decision process (MDP). The deep reinforcement learning (DRL) engine 111 includes graph neural network data and deep q-network data. The plurality of topology synthesis data TS1 are related to joint topology construction data, topology attribute data, and routing path data.

In one embodiment, the network design method 600 further includes the following steps: modifying communication path data to minimize power data and area data by reinforcement learning agent while meeting performance constraint data. The cost function data CF1 includes the power data and the area data. The communication path data is related to the routing path data; the deep reinforcement learning (DRL) engine 111 includes the reinforcement learning agent. The topology synthesis data TS1 is related to a network-on-chip (NoC) data.

In one embodiment, the network design method 600 further includes the following steps: optimizing topology data through the reinforcement learning agent by merging or decoding the communication path data. The topology data is related to the optimized topology data OT1.

In one embodiment, the network design method 600 further includes the following steps: optimizing the topology data through the reinforcement learning agent by assigning a plurality of attribute data to the topology data.

In one embodiment, the plurality of attribute data includes clock config data and data-width config data.

In one embodiment, the network design method 600 further includes the following steps: encoding topology state data by the graph neural network data while optimizing the topology data.

In one embodiment, the topology state data is related to the topology data. The topology state data includes current topology data, the plurality of attribute data, routing path status data. The routing path status data is related to the routing path data. The topology state data correspond to state feature data and graph data.

In one embodiment, the network design method 600 further includes the following steps: obtaining the input specification data IS1 by an input interface; and verifying and outputting the optimized topology data OT1 by an output module. The network design system 100 further includes the input interface and the output module.

In one embodiment, the network design method 600 further includes the following steps: jointly optimizing at least one of protocol data, link type data, voltage data, and custom attribute data according to the reinforcement learning (RL) task data; and jointly optimizing Network-on-Chip (NoC) topology design dimension data according to the reinforcement learning (RL) task data.

In one embodiment, the plurality of topology synthesis data TS1 comprise at least one of the protocol data, the link type data, the voltage data, and the custom attribute data.

In one embodiment, the protocol data, the link type data, the voltage data, and the custom attribute data are related to the cost function data CF1.

In one embodiment, the Network-on-Chip (NoC) topology design dimension data is related to one of the plurality of topology synthesis data.

In some embodiments, the network design method 600 may be implemented in any type of programming language code, algorithm, software, or firmware, but the present disclosure is not limited thereto.

In some embodiments, the network design method 600 may be implemented by the network design system 100, but the present disclosure is not limited thereto. In some embodiments, the network design method 600 may be implemented by a non-transitory computer-readable storage medium, but the present disclosure is not limited thereto. In some embodiments, the network design method 600 may be implemented by other systems or servers, but the present disclosure is not limited thereto.

Therefore, according to the technical content of the present disclosure, the network design system and network design method shown in the embodiment of the present disclosure can achieve the effect of performing automated transformation and self-learning.

Furthermore, the network design system and network design method of the present disclosure may achieve significant advancements and improvements in NoC topology synthesis by the reinforcement learning (RL) framework (such as the deep reinforcement learning (DRL) engine).

Moreover, the network design system and network design method of the present disclosure may shift from “segmented” to “Joint Optimization”. Conventional technologies treat topology construction, clock configuration, and routing path planning as independent stages, which often misses the global optimum.

The network design system and network design method may provide the first unified framework for the joint optimization of topology, clock and data width configurations, and routing. This integrated approach breaks the information barriers between stages, achieving superior global performance optimization).

Furthermore, the network design system and network design method of the present disclosure may achieve “End-to-End” automated synthesis. Unlike conventional workflows that require designers to manually coordinate multiple intermediate tools and steps, the network design system and network design method may utilize Deep Reinforcement Learning (DRL) and Graph Neural Network (GNN) to solve the end-to-end topology synthesis problem. This significantly reduces reliance on engineers' domain knowledge and manually tuned heuristic rules, thereby enhancing design efficiency.

Moreover, the network design system and network design method of the present disclosure may enhance “Scalability” and generalization capability. Traditional heuristic rules struggle to handle increasingly complex SoC designs, the network design system and network design method may adopt GNN to encode dynamic topology states, enabling the system to process SoC designs with varying complexity and demonstrating stronger generalization and adaptability.

Furthermore, the network design system and network design method of the present disclosure may achieve “PPA-optimized” results through data-driven methods (such as the flowchart 200 and the flowchart 300). The network design system and network design method may model the optimization task as an RL task (or MDP loop), utilizing a PPA Cost function to accurately estimate power, performance, and area costs, which is then converted into a reward mechanism.

Through continuous “replays” and learning across multiple episodes, the agent eventually produces NoC topologies that are more precise and PPA-optimized compared to traditional heuristic-based methods.

Furthermore, the network design system and network design method of the present disclosure may transform fragmented and manual design processes into a highly automated, data-driven framework capable of joint optimization across multiple dimensions and handling complex designs, ultimately achieving superior overall system performance, but the present disclosure is not limited thereto.

Moreover, the network design system and network design method of the present disclosure may present a novel deep reinforcement learning (DRL)-based framework with graph neural networks (GNNs) for automatic network-on-chip (NoC) topology synthesis in system-on-chips (SoCs). The network design system and network design method formulates topology synthesis as an RL task, which enables joint optimization of key sub-problems including topology generation, clock frequency and data width configuration, and routing decision.

This joint formulation allows RL agent to make globally informed decisions throughout the synthesis process, effectively reducing the risk of obtaining sub-optimal solutions that may arise when these sub-problems are optimized in separate stages. To represent dynamically evolving topologies during optimization, the network design system and network design method may employ a graph-based encoding with GNNs to achieve expressive and static state representations. The use of GNNs further enables the method to scale effectively across designs with varying complexity.

The network design system and network design method may evaluate the method on real-world SoC designs with diverse communication requirements. The results show that the method achieves reduction in area and power cost compared to human-tuned topologies, all while meeting performance constraints.

These improvements highlight the capability of RL to explore vast design spaces for PPA optimization. This work pioneers the use of RL in combination with GNNs for topology synthesis, offering a unified framework for optimizing modern SoC communication networks.

In addition, it should be understood that the ordinal terms such as “first” “second” and the like used in the specification and the claims are employed to modify elements and are not intended to indicate any temporal order of the element(s), nor do they imply any sequence between elements or any sequence in a manufacturing process. The sole purpose of these ordinals is to clearly distinguish elements having similar names from one another. The same terms used in the specification and in the claims need not correspond; for example, an element referred to as a first element in the specification may be referred to as a second element in the claims.

The scope of protection of the present disclosure is not limited to the processes, machines, manufactures, compositions of matter, devices, methods, and steps described in the specific embodiments of the specification. Any person of ordinary skill in the art will understand from the teachings of the present disclosure that existing or future-developed processes, machines, manufactures, compositions of matter, devices, methods, and steps may be used, so long as they can perform substantially the same function or achieve substantially the same result as those in the embodiments described herein. Accordingly, the scope of the present disclosure encompasses such processes, machines, manufactures, compositions of matter, devices, methods, and steps. Any embodiment or claim of the present disclosure does not need to achieve all of the objectives, advantages, and/or features disclosed herein.

The foregoing has outlined several embodiments to assist those of ordinary skill in the art in better understanding the concepts of the embodiments of the present disclosure. It should be understood by those of ordinary skill in the art that, based on the embodiments of the present disclosure, they may design or modify other processes and structures to achieve the same objectives and/or advantages as the embodiments described herein. It should also be understood that such equivalent processes and structures do not depart from the spirit and scope of the present disclosure, and that various changes, substitutions, and alterations can be made without departing from the spirit and scope of the present disclosure.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A network design system, comprising:
a memory, configured to store a plurality of commands and a deep reinforcement learning (DRL) engine; and
a processor, configured to execute following steps according to the plurality of commands of the memory:
obtaining a plurality of topology synthesis data by the deep reinforcement learning (DRL) engine according to input specification data and cost function data; and
outputting optimized topology data through the deep reinforcement learning (DRL) engine by comparing the plurality of topology synthesis data;
wherein the optimized topology data is related to a maximum value of reward data;
wherein the reward data is related to the cost function data.

2. The network design system as claimed in claim 1, wherein the processor executes the following steps according to the plurality of commands of the memory:
formulating one of the plurality of topology synthesis data as a reinforcement learning (RL) task data by the deep reinforcement learning (DRL) engine; and
jointly optimizing the topology synthesis data, clock config data, data-width config data, and routing path data according to the reinforcement learning (RL) task data;
wherein the reinforcement learning (RL) task data is related to a topology transformation data.

3. The network design system as claimed in claim 2, wherein
the processor executes the following steps according to the plurality of commands of the memory:
encoding dynamic topology state data as graph data by reinforcement learning agent with graph neural network data according to the reinforcement learning (RL) task data; and
obtaining a value of the cost function data by the deep reinforcement learning (DRL) engine according to the graph data;
wherein the reinforcement learning agent is related to the deep reinforcement learning (DRL) engine;
wherein the graph neural network data is related to the deep reinforcement learning (DRL) engine;
wherein the graph data is related to one of the plurality of topology synthesis data;
wherein one of the plurality of topology synthesis data corresponds to end-to-end topology data.

4. The network design system as claimed in claim 3, wherein
the processor executes the following steps according to the plurality of commands of the memory:
obtaining first topology state data by the reinforcement learning agent;
observing first current topology data of the first topology state data by the reinforcement learning agent;
transforming first topology structure data of the plurality of topology synthesis data by the reinforcement learning agent;
obtaining a first difference value of the cost function data as the reward data;
obtaining second topology state data by the reinforcement learning agent;
observing second current topology data of the second topology state data by the reinforcement learning agent;
transforming second topology structure data of the plurality of topology synthesis data by the reinforcement learning agent;
obtaining a second difference value of the cost function data as the reward data; and
outputting the optimized topology data through the deep reinforcement learning (DRL) engine according to the reward data;
wherein the first topology state data and the second topology state data are related to the plurality of topology synthesis data;
wherein the first current topology data and the second current topology data are related to the plurality of topology synthesis data.

5. The network design system as claimed in claim 1, wherein
the topology synthesis data is related to a Markov decision process (MDP);
wherein the deep reinforcement learning (DRL) engine includes graph neural network data and deep q-network data;
wherein the plurality of topology synthesis data are related to joint topology construction data, topology attribute data, and routing path data.

6. The network design system as claimed in claim 5, wherein
the topology synthesis data is related to a network-on-chip (NoC) data;
wherein the processor executes the following steps according to the plurality of commands of the memory:
modifying communication path data to minimize power data and area data by reinforcement learning agent while meeting performance constraint data;
wherein the cost function data comprises the power data and the area data;
wherein the communication path data is related to the routing path data;
wherein the deep reinforcement learning (DRL) engine comprises the reinforcement learning agent.

7. The network design system as claimed in claim 6, wherein
the processor executes the following steps according to the plurality of commands of the memory:
optimizing topology data through the reinforcement learning agent by merging or decoding the communication path data;
wherein the topology data is related to the optimized topology data.

8. The network design system as claimed in claim 7, wherein
the processor executes the following steps according to the plurality of commands of the memory:
optimizing the topology data through the reinforcement learning agent by assigning a plurality of attribute data to the topology data;
wherein the plurality of attribute data comprises clock config data and data-width config data.

9. The network design system as claimed in claim 8, wherein
the processor executes the following steps according to the plurality of commands of the memory:
encoding topology state data by the graph neural network data while optimizing the topology data;
wherein the topology state data is related to the topology data;
wherein the topology state data comprises current topology data, the plurality of attribute data, routing path status data;
wherein the routing path status data is related to the routing path data;
wherein the topology state data correspond to state feature data and graph data.

10. The network design system as claimed in claim 9, wherein
the processor executes the following steps according to the plurality of commands of the memory:
obtaining the input specification data by an input interface;
verifying and outputting the optimized topology data by an output module;
jointly optimizing at least one of protocol data, link type data, voltage data, and custom attribute data according to the reinforcement learning (RL) task data; and
jointly optimizing Network-on-Chip (NoC) topology design dimension data according to the reinforcement learning (RL) task data;
wherein the network design system further comprises the input interface and the output module;
wherein the plurality of topology synthesis data comprise at least one of the protocol data, the link type data, the voltage data, and the custom attribute data;
wherein the protocol data, the link type data, the voltage data, and the custom attribute data are related to the cost function data;
wherein the Network-on-Chip (NoC) topology design dimension data is related to one of the plurality of topology synthesis data.

11. A network design method, comprising:
obtaining a plurality of topology synthesis data by a deep reinforcement learning (DRL) engine according to input specification data and cost function data; and
outputting optimized topology data through the deep reinforcement learning (DRL) engine by comparing the plurality of topology synthesis data;
wherein the optimized topology data is related to a maximum value of reward data;
wherein the reward data is related to the cost function data.

12. The network design method as claimed in claim 11, further comprising:
formulating one of the plurality of topology synthesis data as a reinforcement learning (RL) task data by the deep reinforcement learning (DRL) engine; and
jointly optimizing the topology synthesis data, clock config data, data-width config data, and routing path data according to the reinforcement learning (RL) task data;
wherein the reinforcement learning (RL) task data is related to a topology transformation data.

13. The network design method as claimed in claim 12, further comprising:
encoding dynamic topology state data as graph data by reinforcement learning agent with graph neural network data according to the reinforcement learning (RL) task data; and
obtaining a value of the cost function data by the deep reinforcement learning (DRL) engine according to the graph data;
wherein the reinforcement learning agent is related to the deep reinforcement learning (DRL) engine;
wherein the graph neural network data is related to the deep reinforcement learning (DRL) engine;
wherein the graph data is related to one of the plurality of topology synthesis data;
wherein one of the plurality of topology synthesis data corresponds to end-to-end topology data.

14. The network design method as claimed in claim 13, further comprising:
obtaining first topology state data by the reinforcement learning agent;
observing first current topology data of the first topology state data by the reinforcement learning agent;
transforming first topology structure data of the plurality of topology synthesis data by the reinforcement learning agent;
obtaining a first difference value of the cost function data as the reward data;
obtaining second topology state data by the reinforcement learning agent;
observing second current topology data of the second topology state data by the reinforcement learning agent;
transforming second topology structure data of the plurality of topology synthesis data by the reinforcement learning agent;
obtaining a second difference value of the cost function data as the reward data; and
outputting the optimized topology data through the deep reinforcement learning (DRL) engine according to the reward data;
wherein the first topology state data and the second topology state data are related to the plurality of topology synthesis data;
wherein the first current topology data and the second current topology data are related to the plurality of topology synthesis data.

15. The network design method as claimed in claim 11, wherein
the topology synthesis data is related to a Markov decision process (MDP);
wherein the deep reinforcement learning (DRL) engine includes graph neural network data and deep q-network data;
wherein the plurality of topology synthesis data are related to joint topology construction data, topology attribute data, and routing path data.

16. The network design method as claimed in claim 15, further comprising:
modifying communication path data to minimize power data and area data by reinforcement learning agent while meeting performance constraint data;
wherein the cost function data comprises the power data and the area data;
wherein the communication path data is related to the routing path data;
the deep reinforcement learning (DRL) engine comprises the reinforcement learning agent;
wherein the topology synthesis data is related to a network-on-chip (NoC) data.

17. The network design method as claimed in claim 16, further comprising:
optimizing topology data through the reinforcement learning agent by merging or decoding the communication path data;
wherein the topology data is related to the optimized topology data.

18. The network design method as claimed in claim 17, further comprising:
optimizing the topology data through the reinforcement learning agent by assigning a plurality of attribute data to the topology data;
wherein the plurality of attribute data comprises clock config data and data-width config data.

19. The network design method as claimed in claim 18, further comprising:
encoding topology state data by the graph neural network data while optimizing the topology data;
wherein the topology state data is related to the topology data;
wherein the topology state data comprises current topology data, the plurality of attribute data, routing path status data;
wherein the routing path status data is related to the routing path data;
wherein the topology state data correspond to state feature data and graph data.

20. The network design method as claimed in claim 19, further comprising:
obtaining the input specification data by an input interface;
verifying and outputting the optimized topology data by an output module;
jointly optimizing at least one of protocol data, link type data, voltage data, and custom attribute data according to the reinforcement learning (RL) task data; and
jointly optimizing Network-on-Chip (NoC) topology design dimension data according to the reinforcement learning (RL) task data;
wherein a network design system further comprises the input interface and the output module;
wherein the network design system comprises the network design method;
wherein the plurality of topology synthesis data comprise at least one of the protocol data, the link type data, the voltage data, and the custom attribute data;
wherein the protocol data, the link type data, the voltage data, and the custom attribute data are related to the cost function data;
wherein the Network-on-Chip (NoC) topology design dimension data is related to one of the plurality of topology synthesis data.
